(19) United States
(12) Patent Application Publication
(10) Pub. No.: US 2007/0254128 A1
(43) Pub. Date: Nov. 1, 2007

(54) Modular Labeling System

(76) Inventor: Stephen Bruce Lober, Athens, GA (US)

Correspondence Address: NEEDLE & ROSENBERG, P.C., SUITE 1000, 999 PEACHTREE STREET, ATLANTA, GA, 30309-3915, US

(21) Appl. No.: 11/688,598

(22) Filed: Mar. 20, 2007

Related U.S. Application Data
(60) Provisional application No. 60/784,205, filed on Mar. 20, 2006.

(51) Int. Cl. B32B 33/00

(52) U.S. Cl. 428/42.3

(57) ABSTRACT

The invention relates to a modular labeling system for use in and around an operating room of a hospital. The labeling system comprises at least one sheet of labels, each label configured to be affixed to a container containing a solution. Each sheet of labels comprises a plurality of primary labels and a plurality of secondary labels. The primary labels are pre-printed with names of frequently used solutions. The secondary labels are pre-printed with names of other solutions, which can be used in conjunction with or in lieu of the frequently used solutions.

### CROSS-REFERENCE TO RELATED APPLICATION

This application claims priority to and the benefit of U.S. Patent Application No. 60/784,205, entitled “Modular Labeling System,” filed on Mar. 20, 2006, which is incorporated in its entirely in this document by reference.

### FIELD OF THE INVENTION

The present invention pertains to a labeling system. More specifically, the invention relates to modular labeling system for use in a hospital.

### BACKGROUND OF THE INVENTION

In a hospital operating room, all medications on the sterile field should be labeled properly. Medication use in the operating room is a complex process fraught with potential for error. Additional medications could be added to the field during the procedure, and an error could occur if the medication has not been labeled. During a busy procedure, the scrub person may become distracted and mistake one solution for another. In addition, confusion and miscommunication can occur when the scrub person is relieved during a procedure. The surgeon could pick up an unlabeled syringe and administer the wrong medication. The possibilities for error are great, with errors having grave consequences.

Most medication orders are given verbally, and miscommunication between the physician and nurse is a common cause of medication error. Studies show that more than one in ten medication errors are related directly to the use of incorrect medication names, confusion regarding dosages, and misunderstood abbreviations. As there are few, if any, independent checks in the process, verbal orders leave great room for error.

Operating room personnel should have a policy that specifies the exact steps for safe medication administration. A safe medication administration policy should include, at a minimum, the following specifications.
The medication is checked by an RN and the scrub person before it is transferred to the sterile field.
The scrub person labels the sterile medication container and syringe if used on the sterile field.
The scrub person repeats the name of the medication and the dosage when passing it to the surgeon.
When repeating the dosage, numbers are expressed in single digits (e.g., one-five instead of 15, six-zero instead of 60).

Medication errors resulting in death are estimated to be as high as 140,000 per year, and the National Association of Insurance Commissioners reports that medication errors are the most frequent cause of procedure-related malpractice claims. Careful adherence to safe medication administration practices in the operating room is an important aspect of perioperative nursing care.

In order to facilitate the labeling process of medications on the back table of an operating room, operating room personnel typically use pre-printed labels for common medications. Often times, however, medications are added to the regimen, sometimes in differing concentrations. Current state of the art systems use pens to add medications and record concentrations.

The use of marking pens in this situation is fraught with the likelihood of mistake. Handwriting is often illegible. Ink runs or smudges. Accordingly, the use of such pens and hand written marks may result in potentially ambiguous and unclear markings that may ultimately lead to confusion or worse.

Another problem with the marking pens of the prior art is that they have a tendency to dry out. Some pens dry out in the package and others dry out after a single use.

To overcome these problems, there is a need for a label marking system which enables operating personnel to consistently place a professional looking, uniform, and unambiguous marking onto a label in order to clearly designate the amount, concentration, and name of the back table medication or fluids.

### SUMMARY

In one embodiment, the present invention pertains to a modular labeling system for use in and around an operating room of a hospital. The labeling system comprises at least one sheet of labels, each label configured to be affixed to a container containing a solution.

Each sheet of labels comprises a plurality of primary labels and a plurality of secondary labels. The primary labels are pre-printed with names of frequently used solutions. In one aspect, the primary labels comprise at least one label of each frequently used solution. In another aspect, the primary labels may contain a plurality of some or a plurality of each of the names of frequently used solutions. The primary label may be configured to enable a user to write the concentration or other important information regarding the frequently used solution on the primary label, as well as other pertinent information such as the user's initials or the date.

The secondary labels are pre-printed with names of other solutions, which can be used in conjunction with or in lieu of the frequently used solutions. The secondary labels may, for instance, include additives used with the frequently used solutions. The secondary labels may also have space for the user to write amounts, concentrations, and other pertinent information.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention.

### DETAILED DESCRIPTION OF THE DRAWINGS

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

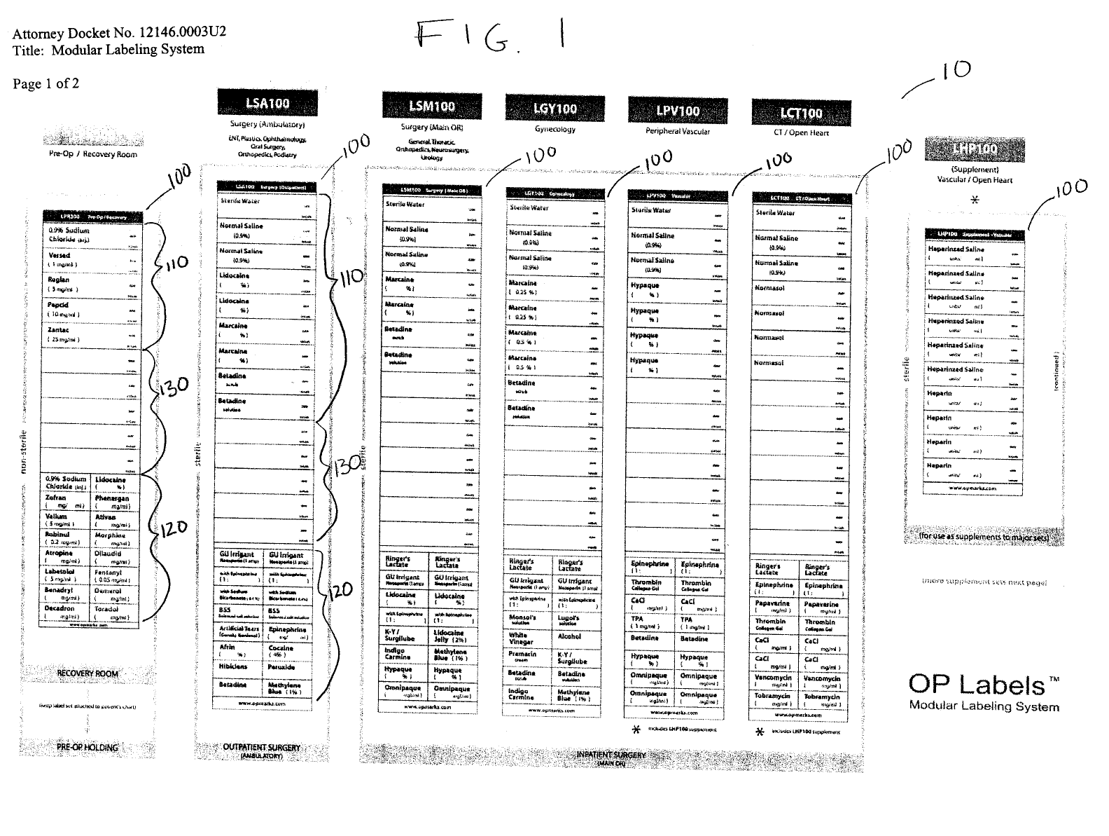

FIG. 1 is an elevational view of the present invention for a modular labeling system showing a plurality of sheets of labels.

FIG. 2 is an elevational view of a sheet of labels of the system of FIG. 1, showing a plurality of primary labels, a plurality of secondary labels, and a plurality of blank labels.

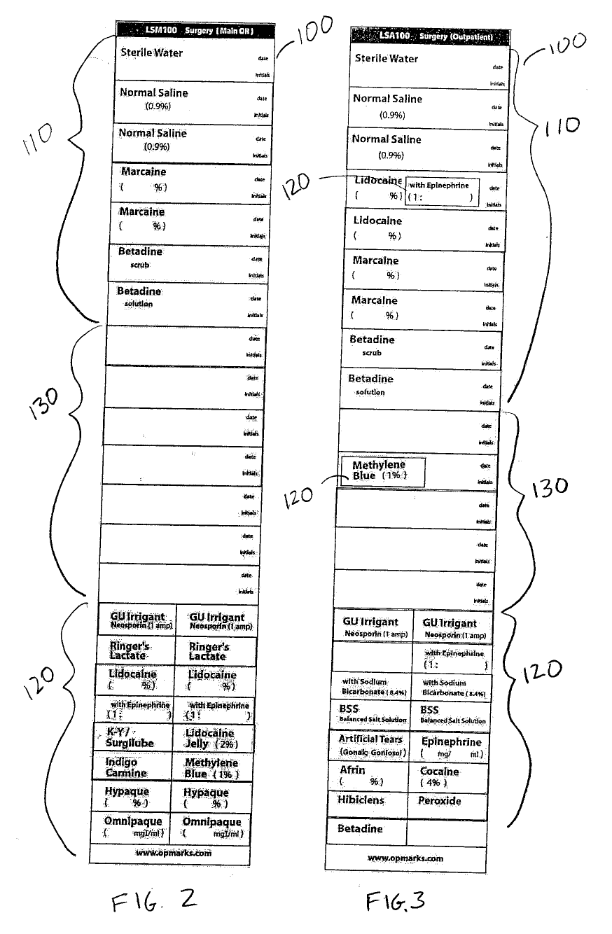

FIG. 3 is an elevational view of a sheet of labels of the system of FIG. 1, showing primary labels and blank labels augmented by secondary labels.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “surface” includes aspects having two or more such surfaces unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The present invention may be understood more readily by reference to the following detailed description of preferred embodiments of the invention and the examples included therein and to the Figures and their previous and following description.

The present invention is a modular labeling system 10 for use in and around an operating room of a hospital. The labeling system comprises at least one sheet 100 of labels, each label configured to be affixed to a container containing a solution. The container may be a vile, a syringe, a bag, or any other similar container for holding medical solutions.

In one aspect, each sheet 100 of labels comprises a plurality of primary labels 110 and a plurality of secondary labels 120. In one aspect of the invention, each sheet of labels contains labels specific to their area of use. For instance, and not meant to be limiting, the system may comprise labels for pre-op, recovery, outpatient, or inpatient areas of the operating room. Additionally, in one aspect, each sheet may contain labels specific to an area of practice within each area of the operating room. For example, the system may contain labels specific to Orthopedics, Gynecology, Vascular, Open Heart Surgery, Oral Surgery, and the like.

In one aspect, the primary labels are pre-printed with names of frequently used solutions. As used herein, the term solution should be interpreted broadly to mean a drug, liquid, powder, or other item dispensed within or around the operating room. In one aspect, the primary labels comprise at least one label of each frequently used solution. In another aspect, the primary labels may contain a plurality of some or a plurality of each of the names of frequently used solutions. For instance, frequently used solutions may be sterile water, normal saline, Lidacaine, Marcaine, and the like. In one aspect, the primary label is configured to enable a user to write the concentration or other important information regarding the frequently used solution on the primary label, as well as other pertinent information such as the user's initials or the date.

The secondary labels 120 are pre-printed with names of other solutions, which can be used in conjunction with or in lieu of the frequently used solutions. The secondary labels may, for instance, include additives used with the frequently used solutions. These additives may include, for example, Epinephrine, Artificial tears, Peroxide, Betadine, and the like. The secondary labels may also have space for the user to write amounts, concentrations, and other pertinent information. In one aspect, the secondary labels are smaller than the primary labels 110, leaving room on the primary label for the user to write pertinent information.

In another aspect of the invention, the system 10 may comprise at least one sheet of labels comprising a plurality of primary labels 110, a plurality of secondary labels 120, and a plurality of blank labels 130. In this aspect, the primary and secondary labels are as discussed herein above. The blank labels 130 can be used in a number of ways. The blank labels provide a label surface for a user to write information regarding a solution that has not been pre-printed on the primary or secondary labels. Additionally, if a solution on a secondary label is used, but is not in conjunction with a solution on a primary label, the secondary label may be affixed to a blank label, either by itself or in conjunction with a hand-written solution. Having blank labels 130 adds to the flexibility of the system and allows for unforeseen solutions to be labeled properly. In the system of the present invention, the primary and secondary labels are pre-printed, which reduces the possibility of operating room mistakes based on mis-labeling or simply bad handwriting.

The labels of this system 10 may be packaged in any number of ways. In one aspect, groups of labels are packaged together into Chevron sleeves, along with markers, such as, for example and not meant to be limiting, mini-markers, which facilitate writing on the labels when necessary. In one aspect, the markers are provided in the system and may be non-toxic markers with ultra fine tips. However, as one skilled in the art can appreciate, any conventional marker may be used. The markers can comprise a non-erasable ink so that the written instructions on the labels in use cannot be erased during the prescribed procedure. In one aspect, the markers comprise black ink that is ASTM D4236 conforming.

In another aspect of the invention, the system can be formed of sterile components. However, it is contemplated that the system can also comprise at least one non-sterile component. In a further aspect, the labels may be color coded to further indicate areas of use. For instance, a blue colored label may indicate that it is for use in a sterile environment.

The preceding description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. The corresponding structures, materials, acts, and equivalents of all means or step plus function elements in the claims below are intended to include any structure, material, or acts for performing the functions in combination with other claimed elements as specifically claimed.

Accordingly, those who work in the art will recognize that many modifications and adaptations to the present invention are possible and can even be desirable in certain circumstances and are a part of the present invention. Other embodiments of the invention will be apparent to those skilled in the art from consideration of the specification and practice of the invention disclosed herein. Thus, the preceding description is provided as illustrative of the principles of the present invention and not in limitation thereof. It is intended that the specification and examples be considered as exemplary only, with a true scope and spirit of the invention being indicated by the following claims.

I claim:

1. A modular labeling system for use in and around an operating room of a hospital, the labeling system comprising:
at least one sheet of labels, comprising:
a plurality of primary labels removably attached to the at least one sheet of labels, wherein the primary labels are pre-printed with a first set of data; and
a plurality of secondary labels removably attached to the at least one sheet of labels, wherein the secondary labels are pre-printed with a second set of data;
wherein each label is configured to be affixed to a container which is configured to contain a solution.

2. The labeling system of claim 1, wherein the first and second set of data is pertinent to a specific area of use within the operating room.

3. The labeling system of claim 2, wherein the area of use comprises a pre-op area of the operating room.

4. The labeling system of claim 2, wherein the area of use comprises a recovery area of the operating room.

5. The labeling system of claim 1, wherein the first and second set of data is pertinent to a specific area of practice within the operating room.

6. The labeling system of claim 5, wherein the area of practice comprises Orthopedics.

7. The labeling system of claim 5, wherein the area of practice comprises Gynecology.

8. The labeling system of claim 1, wherein the first set of data comprises names of frequently used solutions.

9. The labeling system of claim 8, wherein the first set of data comprises at least one of each frequently used solution.

10. The labeling system of claim 8, wherein at least one of the plurality of primary labels is configured to enable a user to write a solution concentration of the frequently used solution on or adjacent the primary label.

11. The labeling system of claim 8, wherein the second set of data comprises the names of solutions which may be used with or in lieu of the frequently used solutions.

12. The labeling system of claim 1, wherein the secondary labels are smaller than the primary labels.

13. The labeling system of claim 1, further comprising a plurality of blank labels removably attached to the at least one sheet of labels.

14. The labeling system of claim 13, wherein the blank labels are configured to enable a user to write information regarding the solution on the blank labels.

15. The labeling system of claim 1, further comprising a mini marker comprising non-erasable ink.

16. The labeling system of claim 15, wherein the ink is ASTM D4236 conforming.

17. The labeling system of claim 2, wherein the sheet of labels is color coded to indicate the area of use.

18. The labeling system of claim 1, wherein each of the at least one sheet of labels is sterile.
